(19) United States
(12) Patent Application Publication
(10) Pub. No.: US 2025/0141135 A1
(43) Pub. Date: May 1, 2025

(54) ELECTRICAL CONNECTOR WITH IMPROVED TERMINAL ARRANGEMENT

(71) Applicants: FUDING PRECISION INDUSTRY (SHENZHOU) CO., LTD., Zhengzhou (CN); FOXCONN INTERCONNECT TECHNOLOGY LIMITED, Grand Cayman (KY)

(72) Inventors: QIN-XIN CAO, Kunshan (CN); Hung-Cheng LIAO, New Taipei (TW); Hsuan-Ping CHIANG, New Taipei (TW)

(21) Appl. No.: 18/926,970

(22) Filed: Oct. 25, 2024

(30) Foreign Application Priority Data
Oct. 27, 2023 (CN) 202311412767.0

(51) Int. Cl. H01R 12/57; H01R 13/24; H01R 13/502; H01R 13/6585

(52) U.S. Cl. CPC H01R 12/724; H01R 13/2442; H01R 13/502; H01R 13/6585; H01R 12/57

(57) ABSTRACT

An electrical connector includes: an insulating housing comprising a mating slot; a row of lower terminals arranged along a first direction and located at a lower side of the mating slot, each of the lower terminals including a fixing portion, an elastic arm, a soldering portion, the row of lower terminals including plural pairs of first signal terminals, plural pairs of second signal terminals, and plural grounding terminals, the pairs of first signal terminals and the pairs of second signal terminals being arranged alternately with each other and being separated by the grounding terminals; and a row of upper terminals located at an upper side of the mating slot, wherein, viewed in the first direction, the first signal terminals are aligned with each other, the second signal terminals are aligned with each other, and the second signal terminals protrude deeper into the mating slot than the first signal terminals.

### BACKGROUND OF THE INVENTION

### Field of the Invention

The present invention relates to an electrical connector with improved terminal arrangement.

### Description of Related Arts

For an electrical connector, signal interference from outside and signal crosstalk between signals are becoming more and more serious due to small size of the electrical connector. Reducing signal interference and signal crosstalk is becoming increasingly important and indispensable and many ways are taken to achieve it. For example, a grounding member is used in an electrical connector disclosed in China Patent No. 209169425 to reduce signal crosstalk. Currently, companies in a connector field are committed to developing electrical connectors suitable for high-frequency and high-speed signals to adapt for new generation products.

Therefore, it is necessary to provide an electrical connector with improved terminal arrangement.

### SUMMARY OF THE INVENTION

The object of the present invention is to provide an electrical connector with improved terminal arrangement.

To achieve the above object, an electrical connector comprises: an insulating housing comprising a mating slot; a row of lower terminals arranged along a first direction and located at a lower side of the mating slot, each of the lower terminals comprising a fixing portion and an elastic arm and a soldering portion extending from opposite ends of the fixing portion respectively, the row of lower terminals comprising plural pairs of first signal terminals, plural pairs of second signal terminals, and plural grounding terminals, the pairs of first signal terminals and the pairs of second signal terminals being arranged alternately with each other and being separated by the grounding terminals; and a row of upper terminals located at an upper side of the mating slot, wherein, viewed in the first direction, the first signal terminals are aligned with each other, the second signal terminals are aligned with each other, and the second signal terminals protrude deeper into the mating slot than the first signal terminals.

Other advantages and novel features of the invention will become more apparent from the following detailed description of the present embodiment when taken in conjunction with the accompanying drawings.

### BRIEF DESCRIPTION OF THE DRAWING

FIG. 1 is a perspective view of an electrical connector mounted on a circuit board, of an embodiment of this present invention;

FIG. 2 is a perspective view of the electrical connector separated from the circuit board in FIG. 1;

FIG. 3 is an exploded perspective view of the electrical connector of FIG. 1;

FIG. 4 is a perspective view of two terminal modules in FIG. 3;

FIG. 5 is another perspective view of FIG. 4;

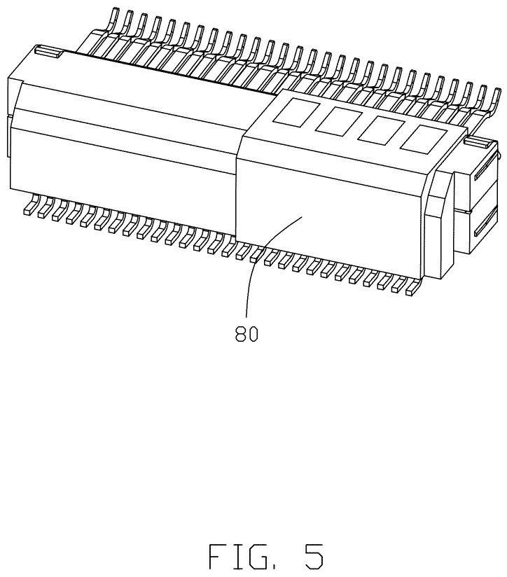

FIG. 6 is an exploded perspective view of an upper terminal module of FIG. 4;

FIG. 7 is a perspective view of a row of upper terminals and two grounding members attached to the upper terminals of FIG. 6.

FIG. 8 is an exploded perspective view of a lower terminal module of FIG. 4;

FIG. 9 is a perspective view of a row of lower terminals and a grounding member attached to the lower terminal of FIG. 8;

FIG. 10 is another perspective view of FIG. 9;

FIG. 11 is a partial front view of FIG. 9; and

FIG. 12 is a right side view of the second terminals of FIG. 9.

### DETAILED DESCRIPTION OF THE PREFERRED EMBODIMENT

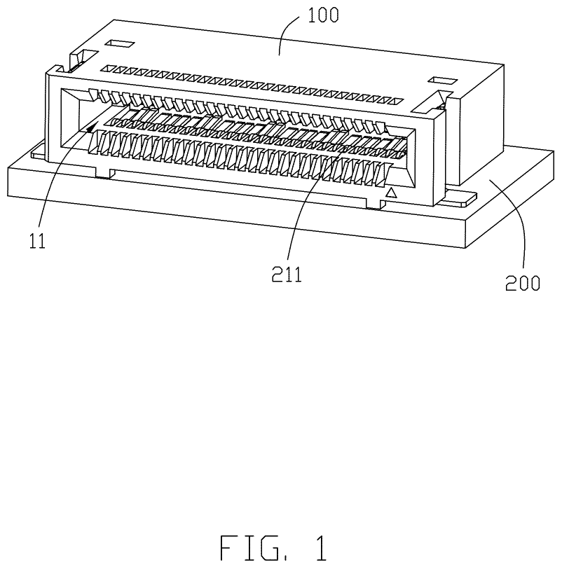

Referring to FIG. 1, an electrical connector 100 adapted for mounting on a circuit board 200 is illustrated. The electrical connector 100 is a high frequency connector which can transmit high frequency signals with high speed. The electrical connector 100 has a longitudinal mating slot 11 for receiving an inserting card assembly or an inserting card of a cable connector assembly.

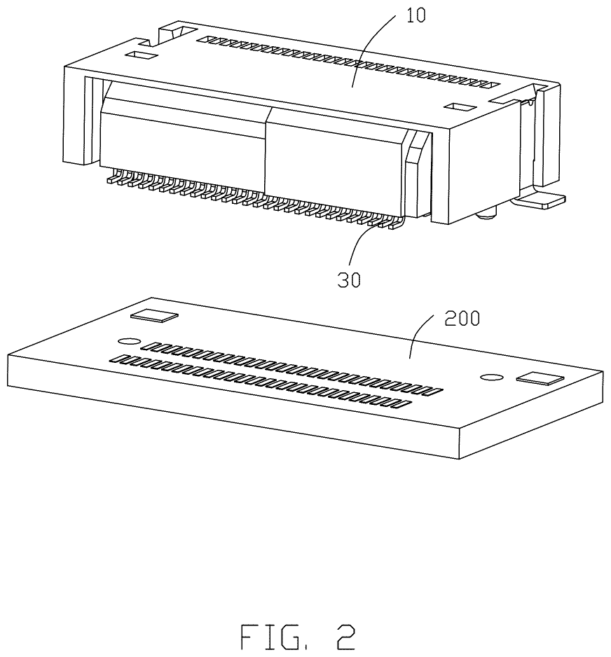

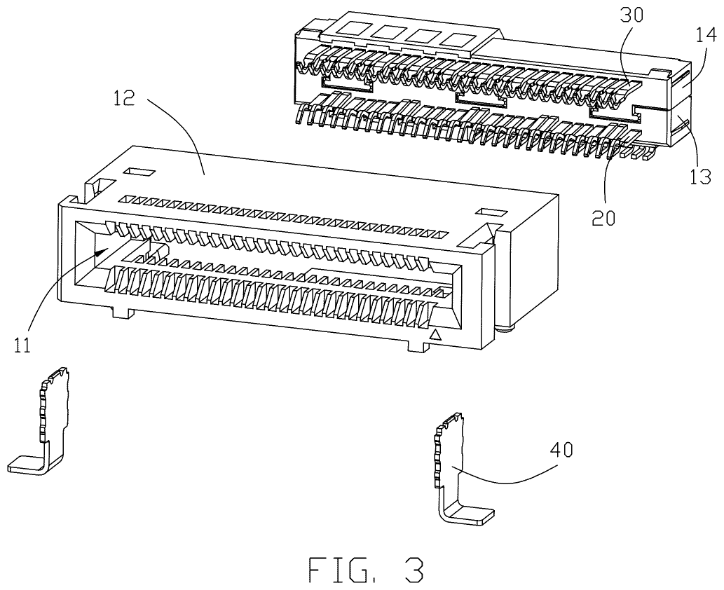

Referring to FIGS. 1-3, the electrical connector 100 comprises an insulating housing 10, a row of first or lower terminals 20 and a row of second or upper terminals 30 retained in the insulating housing 10. The insulating housing 10 comprises an insulating frame 12 with the mating slot 11. The row of first terminals 20 are embedded in a first insulator 13, and the row of second terminals 30 are embedded in a second insulator 14. The first insulator 13 and the second insulator 14 are fixed to each other through a dovetail groove, and then are assembled into the insulating frame 12. The row of first or lower terminals 20 are located in a lower row and the row of second terminals or upper terminals are located in a upper row. Two metal plates 40 are fixed to two ends of the insulating frame 12 respectively, one end of the metal plate 40 is embedded in the insulating frame and the other end extends out of the insulating frame 12 for fixing on the circuit board 200.

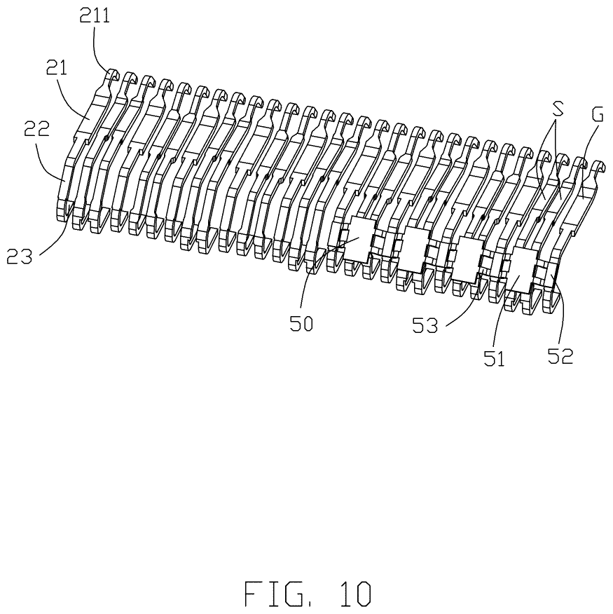

Referring to FIG. 10, each of the first terminal 20 comprises a fixing portion 22, an elastic arm 21 and a soldering portion 23. The elastic arm 21 and the soldering portion 23 extend from two opposite ends of the fixing portion 22 respectively. The elastic arm 21 has an arc contacting portion 211 protruding into the mating slot 11, as shown clearly in FIG. 1.

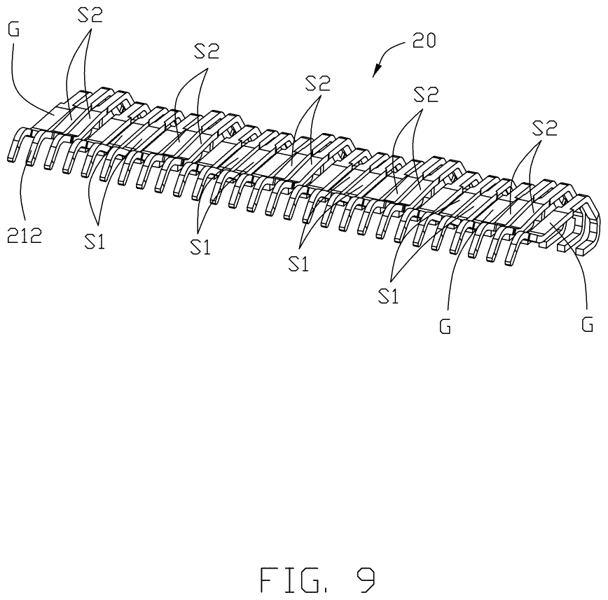

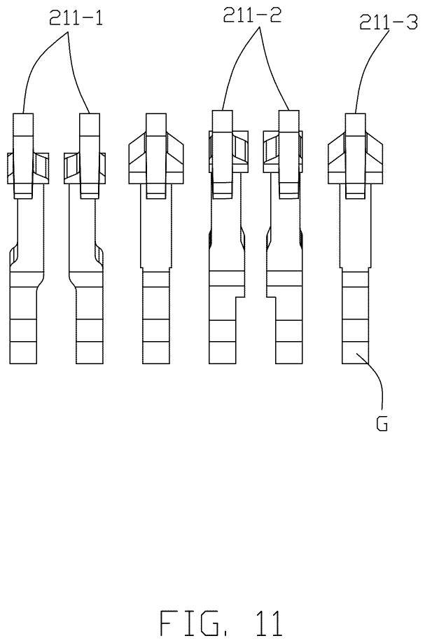

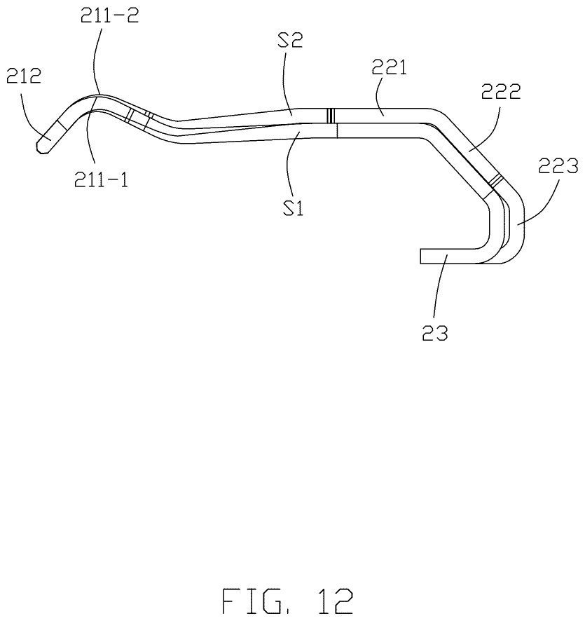

Referring to FIGS. 9-12, the first terminals 20 are rowed along a first direction and comprises plural pairs of first signal terminals S1, plural pairs of second signal terminals S2 and plural grounding terminals G. Each pair of signal terminals is composed of two neighboring terminals for transmitting differential signals. The pairs of first signal terminals S1 and the pairs of second signal terminals S2 are alternatively arranged one by one with each other and are separated by one grounding terminal G. In other embodiments, every two neighboring pairs of first signal terminals S1 and second terminals S2 are separated by two grounding terminals or even more grounding terminals. The improvement of the present invention is that the pairs of second signal terminals S2 in the lower row are located higher than other terminals in the lower row, in other words, the second signal terminals S2 in the lower row are closer to a longitudinal central axis of the mating slot 11 in an upper and lower direction than other terminals in the lower row. In the first direction, the contacting portions 211-1 of the first signal terminals S1 of the lower row are aligned with each other and the contacting portions 211-2 of the second signal terminals S2 of the lower row are aligned with each other, and the contacting portions 211-2 of the second signal terminals S2 protrudes deeper into the mating slot 11 than the contacting portions 211-1 of the first signal terminals S1. Contacting portions 211-3 of all the grounding terminals G are aligned with the contacting portions 211-1 of all the first signal terminals S1 in the lower row, particularly, the whole grounding terminals G are aligned with the whole first signal terminals S1. The inserting card of the inserting card assembly or the cable assembly could get more stable support by the contacting portions 211-2 of the second signal terminals S2 as the contacting portions 211-2 of the second signal terminals S2 protrudes into the mating slot 11 deeper, thus, a stable and tightly mating is made between the electrical connector 100 and the inserting card assembly or the cable connector assembly. As shown in FIG. 12, seen in the first direction, the second signal terminals S2 are intended to separate from the first signal terminals S1 as larger as possible. Understood, adjacent pairs of the first and second signal terminals are offset from each as larger as possibly, thereby reduce cross-talk produced from each other. The fixing portions of the second signal terminals S2 are wholly offset from that of the first signal terminals S1, the elastic arms of the second signal terminals S2 are partially offset from that of the first signal terminals S1, so as to keep the contacting portions of the second signal terminals and the first signal terminals with a small distance to touch with the inserting card. That means, the contacting portions of the first and second signal terminals can be separated from each other with a larger distance in other embodiments. Alternatively, the contacting portions of the second signal terminals and the first signal terminals are located in a same level in the upper and lower direction.

The soldering portions 23 of the first signal terminals 21S, the second signal terminals 22S and the grounding terminals G are aligned with each other. The elastic arm 21 of the first signal terminal 21S comprises a guiding portion 212 in the front of the contacting portion 211-1. The guiding portion 212 inclines from the contacting portion 211-1 in a direction away from the mating slot 11. Guiding portions 212 of the first signal terminals 21S, the second signal terminals 22S and the grounding terminals G are overlapped with each other when viewed from the first direction.

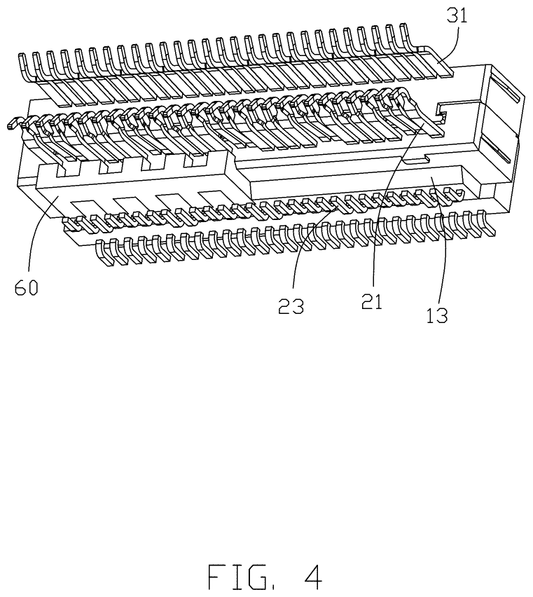

Referring to FIG. 10, the signal terminals of the first terminals 20 comprise the pairs of first signal terminals 21S and the pairs of the second terminals 22S. Both the pairs of the first signal terminals 21S and the pairs of the second signal terminals 22S consist of two neighboring signal terminals S. Both the grounding terminals G and the signal terminals S are characteristic in that a width of the elastic arm 21 is larger than a width of the fixing portion 22 and a width of the soldering portion 23 respectively, the widths of the contacting portion 211 and the guiding portion 212 are reduced suddenly and even smaller than the width of the fixing portion 22. As shown clearly in FIG. 4, the fixing portion 22 is embedded in the first insulator 13 and the elastic arm 21 extending from the fixing portion 22 is exposed out of the first insulator 13, and the smaller width of the fixing portion 22 makes the fixing portion 22 more suitable for being embedded in the first insulator 13. The difference between the grounding terminal G and the signal terminal S is that the width of the elastic arm 21 of the signal terminal is larger than the width of the elastic arm 21 of the grounding terminal G. In each pair of the first signal terminals 21S or the second signal terminals 22S, the two contacting portions 211-1 or 211-2 are aligned with each other and spaced with a certain distance, and the two elastic arms 21 of the first signal terminals 21S or the second signal terminals 22S are widened inwards so that the distance between the two elastic arms 21S becomes smaller. In this embodiment, the electrical connector 100 is adapted for matting with EDSFF (Enterprise and Datacenter Small Form Factor) Modules, and four pairs of signal terminals are used for transmitting high frequency signals, and a first grounding member 50 is used to help reduce signal interference.

The first grounding member 50 comprises four shielding portions 51, five grounding portions 52 and two connecting bars 53 connecting the shielding portions 51 and the grounding portions 52. The fixing portion 22 of the first terminals 20 comprises a horizontal portion 221, an inclined portion 222 and a vertical portion 223 in order, as shown clearly in FIG. 12. In this embodiment, the vertical portions 223 connecting with the soldering portion 23 are embedded in the first insulator 13, and the vertical portions 223 can also be exposed outside the first insulator 13 in other embodiments. The shielding portions 51 are located outside the inclined portions 222 and are substantially parallel to corresponding pairs of inclined portions 222. The grounding portions 52 are tightly attached to the inclined portions 222 of the grounding terminals G of the first terminals 20 for electrically connecting. In other embodiments, the first grounding member 50 can be long enough to span and contact all the grounding terminals G. The shielding portion 51 has substantially a same size as the inclined portion 222 for shielding the inclined portion 222. The shielding portion 51 and the grounding portion 52 are both plate-like and parallel with each other, and are connected by oblique connecting bars, and the first grounding member 50 can be made by an integral metal plate.

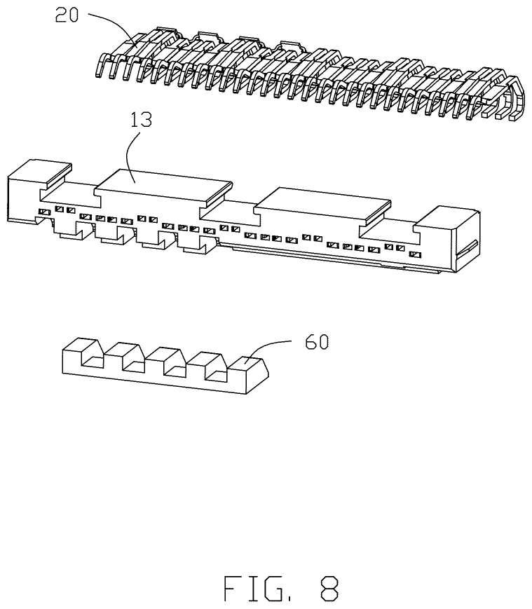

Referring to FIGS. 4 and 8, the electrical connector 100 further comprises a first absorbing member 60, the first insulator 13 has plural grooves and bulges located at a lower face thereof, and the bulges face the pairs of signal terminals S. The first absorbing member 60 has plural mating grooves and mating bulges for cooperating with the bulges and the grooves respectively. The first absorbing member 60 is able to absorb electromagnetic wave and then transform the electromagnetic wave to heat, and restrain cross-talk in effective signals. The first grounding member 50 and the first absorbing member 60 are located at two opposite sides of the row of first terminals 20 respectively for better restraining of cross-talk. The first absorbing member 60 can be fixed to the first insulator 13 to form a terminal module by assembling or injection molding.

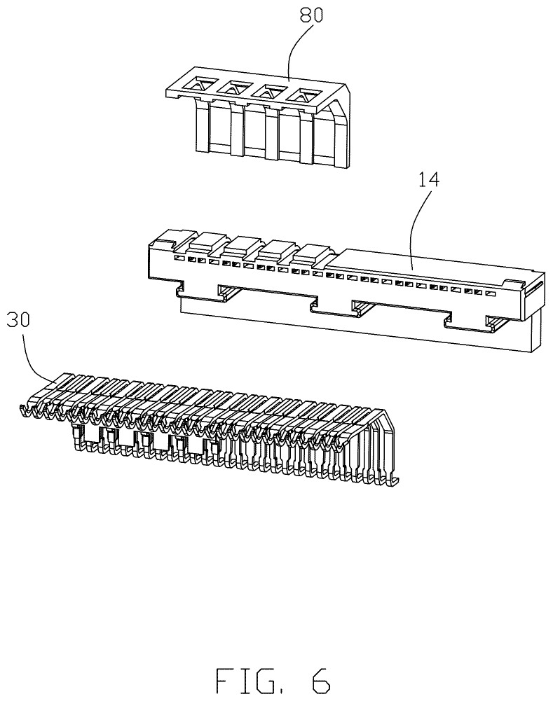

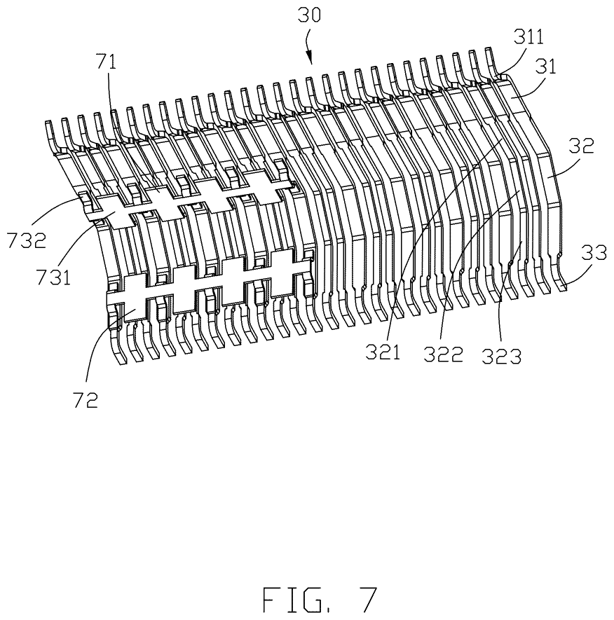

Referring to FIGS. 6-7, the second terminal 30 comprises a fixing portion 32, and an elastic arm 31 and a soldering portion 33 extending from the fixing portion. The elastic arm 31 has a contacting portion 311 protruding into the mating slot 11. In this embodiment, the electrical connector 100 is a right angle connector, the row of first terminals 20 are located at one side of the mating slot 11 near the circuit board 200, the row of second terminals 30 are located at the other side of the mating slot 11. The contacting portions 311 of the second terminals 30 and even the whole second terminals 30 are aligned with each other.

Similar to the first terminals 20, the row of the second terminals 30 comprise plural pairs of signal terminals and plural grounding terminals. As the second terminals are at an upper side of the mating slot, the second terminal has longer fixing portion 32 which comprises a horizontal portion 321, an inclined portion 322 and a vertical portion 323, compared with the first/lower terminals 20. The contacting portions 311 and the soldering portions 33 of the signal terminals S have a same width as the contacting portions 311 and the soldering portions 33 of the grounding terminals G respectively. The elastic arm 31 and the fixing portion 32 of the grounding terminals have a larger width than the elastic arm 31 and the fixing portion 32 of the signal terminals S respectively. As the fixing portion 32 is embedded in the second insulator 14, the decrease of the width of the fixing portion 32 could reduce the impedance of the signal terminals of the second terminals 30. The electrical connector 100 further comprises a second grounding member 71 and a third grounding member 72 which are substantially same. The second grounding member 71 faces the horizontal portion 321 and the third grounding member 72 faces the vertical portion 323. Each grounding member comprises plural shielding portions 731 and plural grounding portions 732. A second absorbing member 80 is located at an outside of the row of the second terminals 30. The second insulator 14, the row of the second terminals 30, the second grounding member 71, the third grounding member 73 and the second absorbing member 80 form another terminal module. The second grounding member 71, the third grounding member 72 and the second absorbing member 80 are able to improve the high frequency of the second terminals 30. The first grounding member 50, the second grounding member 71 and the third grounding member 72 are complementarily located between the row of the first terminals 20 and the row of the second terminals 30 to prevent signal interference between the two rows of terminals.

The above-mentioned embodiments are only preferred embodiments of the present invention, and should not limit the scope of the present invention, any simple equivalent changes and modifications made according to the claims of the present invention and the contents of the description should still belong to the present invention.

1. A right angled electrical connector adapted for being fixed on a printed circuit board, comprising:
an insulating housing comprising a mating slot;
a row of lower terminals arranged along a first direction and located at a lower side of the mating slot, each of the lower terminals comprising a fixing portion and an elastic arm and a soldering portion extending from opposite ends of the fixing portion respectively, the row of lower terminals comprising plural pairs of first signal terminals, plural pairs of second signal terminals, and plural grounding terminals, the pairs of first signal terminals and the pairs of second signal terminals being arranged alternately with each other and being separated by the grounding terminals; and
a row of upper terminals located at an upper side of the mating slot;
wherein, viewed in the first direction, the first signal terminals are aligned with each other, the second signal terminals are aligned with each other, and the second signal terminals protrude deeper into the mating slot than the first signal terminals.

2. The right angled electrical connector as claimed in claim 1, wherein the soldering portions of all the lower terminals are at a same horizontal level.

3. The right angled electrical connector as claimed in claim 1, wherein the upper terminals are aligned with each other in the first direction.

4. The right angled electrical connector as claimed in claim 1, further comprising plural grounding members attached to the grounding terminals of the upper terminals.

5. The right angled electrical connector as claimed in claim 1, wherein the grounding terminals of the lower terminals are aligned with the first signal terminals in the first direction.

6. An electrical connector comprising:
an insulating housing having a mating slot;
a row of first terminals arranged in a first direction and comprising plural pairs of first signal terminals, plural pairs of second signal terminals, and plural grounding terminals, each of the first terminals comprising a fixing portion and an elastic arm and a soldering portion extending from opposite ends of the fixing portion respectively, the elastic arm having an arc contacting portion extending into the mating slot;
wherein, viewed in the first direction, the first signal terminals are wholly overlapped with each other, the second signal terminals are wholly overlapped with each other, the elastic arms of the second signal terminals are offset from the elastic arms of the first signal terminals, and the fixing portions of the second signal terminals are offset from the fixing portions of the first signal terminals.

7. The electrical connector as claimed in claim 6, wherein the grounding terminals are wholly overlapped with the first signal terminals.

8. The electrical connector as claimed in claim 6, wherein, viewed in the first direction, the soldering portions of the first signal terminals and the soldering portions of the second signal terminals are partially overlapped with each other.

9. The electrical connector as claimed in claim 6, further comprising a row of second terminals each including a fixing portion and an elastic arm and a soldering portion extending from opposite ends of the fixing portion respectively, wherein the second terminals are aligned with each other in the first direction.

10. The electrical connector as claimed in claim 9, further comprising a first insulator, a first grounding member, and a first absorbing member, the fixing portions of the row of first terminals are embedded in the first insulator, the first grounding member comprises plural shielding portions and plural grounding portions, the shielding portions face the pairs of first signal terminals and the pairs of second signal terminals one to one, the grounding portions abut against corresponding grounding terminals of the first terminals, and the first absorbing member is attached to an outside of the first insulator without contacting the grounding terminals of the first terminals.

11. The electrical connector as claimed in claim 10, further comprising a second insulator, a second grounding member and a second absorbing member, the second terminals are embedded in the second insulator, the second grounding member comprises plural shielding portions and plural grounding portions, and the second absorbing member is attached to an outside of the second insulator.

12. The electrical connector as claimed in claim 11, wherein each of the fixing portions of the first terminals and the second terminals comprises a horizontal portion, an inclined portion, and a vertical portion, the first grounding member faces the inclined portions of the first terminals, and the second grounding member face the horizontal portion of the second terminals.

13. The electrical connector as claimed in claim 12, further comprising a third grounding member facing the vertical portions of the second terminals.
